(19) United States
(12) Patent Application Publication
(10) Pub. No.: US 2014/0198256 A1
(43) Pub. Date: Jul. 17, 2014

(54) IMAGE PROCESSING APPARATUS AND ASSOCIATED METHOD

(71) Applicant: MStar Semiconductor, Inc., Hsinchu County (TW)

(72) Inventor: Te-Wei Hsu, Hsinchu County (TW)

(73) Assignee: MStar Semiconductor, Inc., Hsinchu County (TW)

(21) Appl. No.: 14/154,572

(22) Filed: Jan. 14, 2014

(30) Foreign Application Priority Data
Jan. 16, 2013 (TW) 102101664

(51) Int. Cl. H04N 9/68

(52) U.S. Cl. CPC H04N 9/68
USPC 348/645

(57) ABSTRACT

An image processing apparatus for processing multiple sets of first image data of an image in a first color space is provided. The first color space is defined by multiple color components excluding a saturation component. The image processing apparatus includes a converting module, a gain determining module and an adjusting module. The converting module converts the multiple sets of first image data to multiple sets of image data in a second color space. The second color space is defined by multiple second color components including the saturation component. The gain determining module determines a saturation gain according to a part of the multiple sets of second data associated with the saturation component. The adjusting module adjusts the image according to the saturation gain.

This application claims the benefit of Taiwan application Serial No. 102101664, filed Jan. 16, 2013, the subject matter of which is incorporated herein by reference.

### BACKGROUND OF THE INVENTION

1. Field of the Invention

The invention relates in general to an image processing technology, and more particularly, to a technology for enhancing image saturation.

2. Description of the Related Art

Accompanied with various prospering electronic products in the recent years, multimedia systems, such as home theaters, continue to gain prevalence. Among the diversified multimedia systems, an image display apparatus is regarded as a critical hardware device. Therefore, how to appropriately adjust an image displayed by the display apparatus to satisfy user preferences has long been a focus of product manufacturers. For example, an image may become clearer by increasing the sharpness of the image, and colors of an image may become more vibrant by increasing the saturation of the image.

Image processing is mostly carried out in a YCbCr color space in current image processing systems (e.g., video cameras, digital televisions and DVD players). In other words, for an input signal in image data represented by the RGB color space, the input signal is first converted to image data represented by the YCbCr color space before further image processing. As known to a person having ordinary skill in the art, three color components Y, Cb and Cr in the YCbCr color space represent luma (brightness), blue-difference chroma and red-difference chroma, respectively, and do not contain saturation. In the YCbCr color space, the saturation of a particular set of image data is indicated by a relationship between the two chroma components Cb and Cr. Therefore, to analyze the saturation of an image in the YCbCr color space, values of Cb and Cr of respective pixels are analyzed. More specifically, a two-dimensional (2D) array formed by values of Cb and Cr of respective pixels is calculated. Such analysis requires a vast amount of computation (more particularly when analyzing high-definition video streams), giving rise to increased hardware costs of the image processing system. As a result, current image processing systems frequently lack the function for individually adjusting the saturation of frames in a dynamic image.

### SUMMARY OF THE INVENTION

The invention is directed to an image processing apparatus and associated method. By converting image data to a color space with color component including a saturation component, saturation information of an image can be effectively identified without involving complicated computations, so that the saturation of the image can be accordingly increased or decreased.

According to an embodiment of the present invention, an image processing apparatus for processing multiple sets of first image data of an image in a first color space is provided. The first color space is defined by multiple color components excluding a saturation component. The image processing apparatus includes a converting module, a gain determining module and an adjusting module. The converting module converts the multiple sets of first image data to multiple sets of image data in a second color space. The second color space is defined by multiple second color components including the saturation component. The gain determining module determines a saturation gain according to a part of the multiple sets of second data associated with the saturation component. The adjusting module adjusts the image according to the saturation gain.

According to another embodiment of the present invention, an image processing method for processing multiple sets of image data of an image in a first color space is provided. The image processing method includes: converting the multiple sets of first image data to multiple sets of second image data in a second color space, wherein the second color space is defined by multiple second color components including a saturation component; determining a saturation gain according to a part of the multiple sets of second data associated with the saturation component; and adjusting the image according to the saturation gain.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of an image processing apparatus according to an embodiment of the present invention;

FIGS. 2(A) to 2(C) are several examples of targets of an adjustment procedure performed by an adjusting module according to an embodiment of the present invention;

FIG. 3 is a flowchart of an image processing method according to an embodiment of the present invention; and

FIG. 4 is an example of a histogram of saturation.

### DETAILED DESCRIPTION OF THE INVENTION

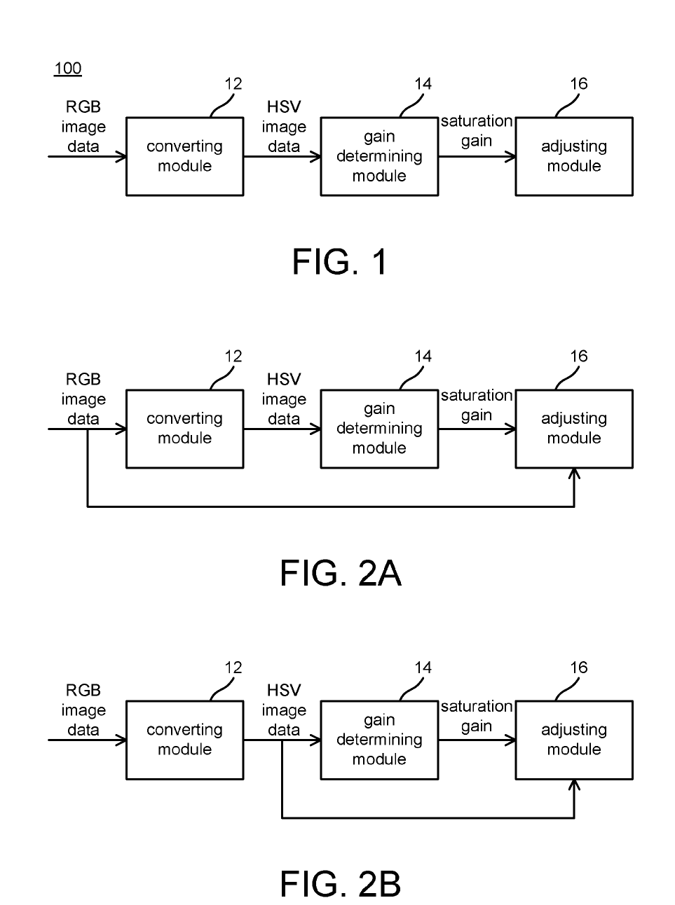

FIG. 1 shows a block diagram of an image processing apparatus according to an embodiment of the present invention. Referring to FIG. 1, an image processing apparatus 100 includes a converting module 12, a gain determining module 14 and an adjusting module 16. In practice, the image processing module 100 may be integrated into various electronic systems with a saturation adjustment requirement, or may be an independent device.

The converting module 12 converts image data between different color spaces. In the embodiment, a first color space is defined by a plurality of first color components, which exclude a saturation component. On the other hand, a second color space is defined by a plurality of second color components, which include the saturation component. In one embodiment, the first color space may be a RGB color space or a YCbCr color space, and the second color space may be an HSV color space, an HSL color space or an HIS color space. In the embodiments below, an example of taking the RGB color space as the first color space and the HSV color space as the second color space is described for illustrating the present invention, not limiting the present invention.

In the embodiment, an input signal inputted into the converting module 12 includes multiple sets of image data (hereinafter, RGB image data) of an image in the RGB color space. In practice, a video stream provided to the image processing apparatus 100 may include multiple images, including the image inputted into the converting module 12, and the image processing apparatus 100 performs image processing on the multiple images in the video stream, respectively. The converting module 12 converts the multiple sets of RGB image data to multiple sets of image data in the HSV color space (hereinafter, HSV image data) according to equations below:

$$H = max ( R , G , B ) - min ( R , G , B ) ;$$

$$V = max ( R , G , B ) ;$$

$$S = \{ \begin{matrix}0 , & if H = 0 \\ \frac{H}{V} , & if H \neq 0\end{matrix}$$

The three color components H, S and V of the HSV color space are defined as hue, saturation and luminance, respectively. That is to say, an output signal from the converting module 12 includes respective saturation information of the multiple sets of image data.

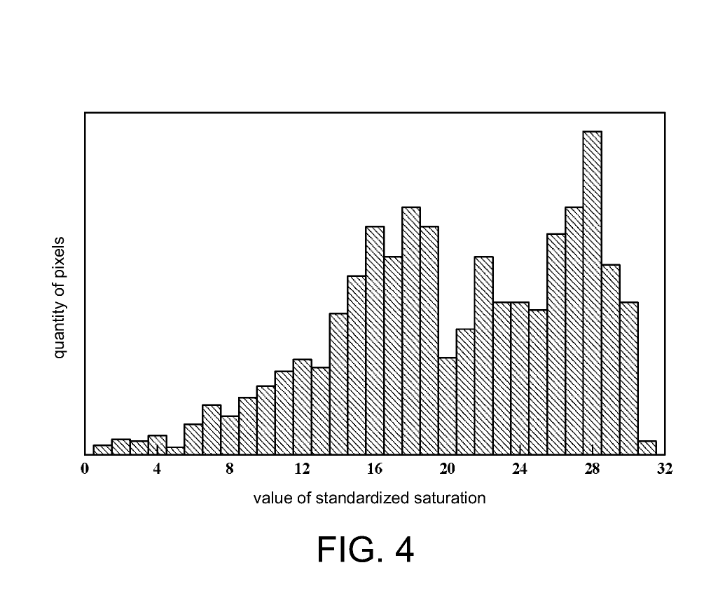

From the HSV image data provided by the converting module 12, the gain determining module 14 determines a saturation gain according to a part associated with the saturation component S. In one embodiment, the gain determining module 14 establishes a histogram of the HSV image data, with the horizontal axis representing the value of the saturation, and the vertical axis representing the quantity of pixels of a specific saturation value in the image. In the exemplary histogram of saturation in FIG. 4, a standardized saturation distribution range is 1 to 32, and the saturation value corresponding to the large quantity of pixels in the histogram is 28. In one embodiment, the gain determining module 14 directly selects 28 as the representative saturation. In another embodiment, from the lowest saturation, the gain determining module 14 accumulates the quantities of pixels corresponding to different saturations, and identifies the saturation corresponding to an accumulation result, whose ratio to the total quantity of pixels is greater than a threshold (e.g., 95%), as the representative saturation of the image.

In practice, there are numerous methods for calculating the saturation gain. In one embodiment, the saturation gain is set as a saturation upper limit divided by the representative saturation (in the above embodiment, dividing 32 by 28). In another embodiment, the saturation gain is set as the representative saturation multiplying a predetermined weighting (e.g., 28 multiplying 1.05 or 0.95). The predetermined weighting may be selected according to the user preference, or may be a fixed value preset before the product is shipped out of the factory.

It should be noted that, regardless of the actual method for generating the saturation gain, since the HSV image data provided to the gain determining module 14 directly includes the respective saturation information of the pixels, the gain determining module 14 is capable of identifying the representative saturation of an image without complex statistics and calculations. In other words, given the definition of the color space corresponding to the output signal of the converting module 12 includes the saturation component, the gain determining module 14 is capably and quickly identifying the saturation information of the image. It should be further noted that, as visual perceptions of different users may vary, there is no absolute optimum standard for the level of saturation of images. Therefore, the gain determining module 14 may determine the method for determining the saturation gain according to the rule of thumb.

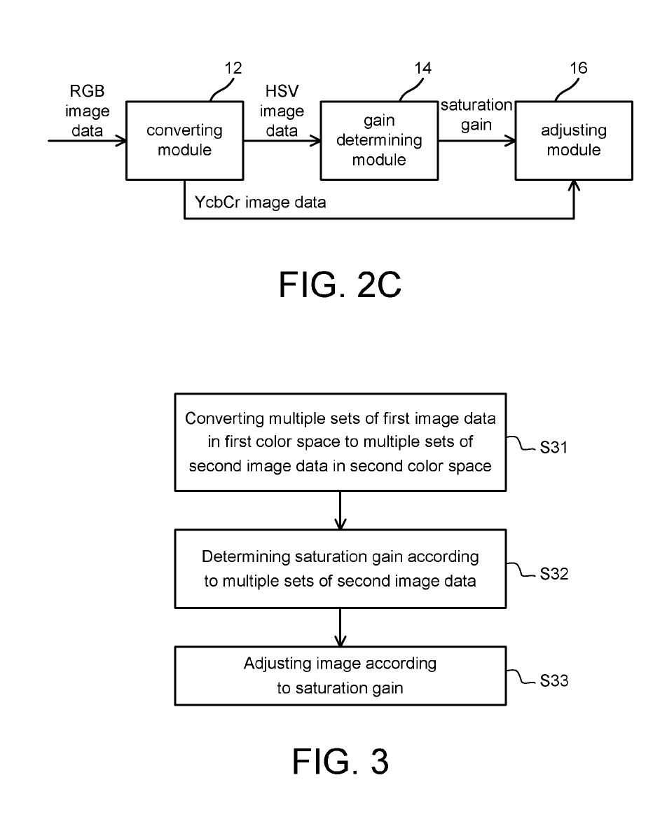

The adjusting module 16 adjusts the image according to the saturation gain generated by the gain determining module 14. In practice, a target to be adjusted by the adjusting module 16 may be determined by a rear-end requirement. In one embodiment, as shown in FIG. 2(A), the adjusting module 16 may change the RGB image data of the image directly according to the saturation gain, e.g., by multiplying the plurality of sets of RGB data by the saturation gain. In another embodiment, as shown in FIG. 2(B), the adjusting module 16 may change the HSV image data of the image according to the saturation gain, e.g., by multiplying the respectively saturation component S in the multiple sets of HSV image data by the saturation gain. When the format of the output signal that the image processing apparatus 100 needs to provide to a rear-end circuit is RGB data, the changed HSV image data may again be converted back to RGB image data.

In another embodiment, as shown in FIG. 2(C), the converting module 12 also converts the RGB image data of an image to another third color space (e.g., the YCbCr color space). Correspondingly, the adjusting module 16 multiples the multiple sets of third image data by the saturation gain according to the saturation gain, respectively, to adjust the image. When the third color space is the YCbCr color space, the adjusting module 16 multiplies the values of Cb and Cr of the multiple sets of image data by the saturation gain, respectively, and keeps the value of Y unadjusted. Such approach provides a benefit that the luminance of the image does not fluctuate along with changes in the saturation.

In practice, the adjusting module 16 may directly utilize the saturation gain provided by the gain determining module 14 as a product for adjusting the image data, or may alternatively identify the product corresponding to the saturation gain according to a look-up table or a predetermined calculation to adjust the image data.

FIG. 3 shows an image processing method according to another embodiment of the present invention. The image processing method processes multiple sets of first image data of an image in a first color space.

The first color space is defined by a plurality of first color components excluding a saturation component. A second color space is defined by a plurality of second color components including the saturation component. The image processing method begins with step S31. In step S31, the multiple sets of first image data is converted to multiple sets of second image data in the second color space. In step S32, a saturation gain is determined according to a part of the multiple sets of second image data associated with the saturation component. In step S33, the image is adjusted according to the saturation gain.

Operation details and variations of the circuits (e.g., the method for determining the saturation gain) given in the description associated with the foregoing image processing apparatus 100 are applicable to the image processing method in FIG. 3, and shall be omitted herein.

As disclosed, in the image processing apparatus and associated method of the present invention, image data is converted to a color space having color components including a saturation component. Accordingly, without involving complex calculations, saturation information of an image can be effectively identified to increase or reduce the saturation of the image. The apparatus and method of the present invention are applicable to electronic systems with an image saturation adjustment requirement (e.g., video cameras, digital televisions and DVD players), for both dynamic images and still images.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image processing apparatus, configured to process a plurality of sets of first image data of an image in a first color space, the first color space defined by a plurality of first color components, the image processing apparatus comprising:
a converting module, configured to convert the plurality of sets of first image data to a plurality of sets of second image data in a second colors space, wherein the second color space is defined by a plurality of second color components including a saturation component;
a gain determining module, configured to determine a saturation gain according to a part of the plurality of sets of second image data associated with the saturation gain; and
an adjusting module, configured to adjust the image according to the saturation gain.

2. The image processing apparatus according to claim 1, wherein the first color space is an RGB color space or a YCbCr color space.

3. The image processing apparatus according to claim 1, wherein the second color space is an HSV color space, an HSL color space or an HIS color space.

4. The image processing apparatus according to claim 1, wherein the gain determining module establishes a saturation histogram of the plurality of sets of second image data to identify a representative saturation, and determines the saturation gain according to the representative saturation.

5. The image processing apparatus according to claim 4, wherein the plurality of sets of second image data correspond to a total pixel quantity; the gain determining module accumulates a pixel quality from a lowest saturation to a highest saturation in the saturation histogram, and, when a ratio of the pixel quantity to the total pixel quantity is greater than a threshold, determines the saturation corresponding to the pixel quantity as the representative saturation.

6. The image processing apparatus according to claim 1, wherein the adjusting module respectively multiples the plurality of sets of first image data by the saturation gain to adjust the image.

7. The image processing apparatus according to claim 1, wherein the adjusting module respectively multiplies the saturation components of the plurality of sets of second image data by the saturation gain to adjust the image.

8. The image processing apparatus according to claim 1, wherein the converting module further converts the plurality of sets of first image data to a plurality of sets of third image data in a third color space, and the adjusting module further respectively multiplies the plurality of sets of image data by the saturation gain to adjust the image.

9. The image processing apparatus according to claim 8, wherein the first color space is an RGB color space, the second color space is an HSV color space, and the third color space is a YCbCr color space; the adjusting module respectively multiplies values of Cb and Cr of the plurality of sets of third image data by the saturation gain to adjust the image.

10. The image processing apparatus according to claim 1, wherein the image is included in a video stream provided to the image processing apparatus, and the image processing apparatus adjusts a plurality of images of the video stream.

11. An image processing method, for processing a plurality of sets of first image data of an image in a first color space, the first color space defined by a plurality of first color components, the image processing method comprising:
a) converting the plurality of sets of first image data to a plurality of sets of second image data in a second colors space, wherein the second color space is defined by a plurality of second color components including a saturation component;
b) determining a saturation gain according to a part of the plurality of sets of second image data associated with the saturation gain; and
c) adjusting the image according to the saturation gain.

12. The image processing method according to claim 11, wherein the first color space is an RGB color space or a YCbCr color space.

13. The image processing method according to claim 11, wherein the second color space is an HSV color space, an HSL color space or an HIS color space.

14. The image processing method according to claim 11, wherein step (b) comprises:
b1) establishing a saturation histogram of the plurality of sets of second image data to identify a representative saturation; and
b2) determining the saturation gain according to the representative saturation.

15. The image processing method according to claim 14, wherein the plurality of sets of second image data corresponds to a total pixel quantity; step (b1) comprises:
accumulating a pixel quality from a lowest saturation to a highest saturation in the saturation histogram; and
when a ratio of the pixel quantity to the total pixel quantity is greater than a threshold, determining the saturation corresponding to the pixel quantity as the representative saturation.

16. The image processing method according to claim 11, wherein step (c) respectively multiples the plurality of sets of first image data by the saturation gain to adjust the image.

17. The image processing method according to claim 11, wherein step (c) respectively multiples the saturation components of the plurality of sets of second image data by the saturation gain to adjust the image.

18. The image processing method according to claim 11, further comprising:
converting the plurality of sets of first image data to a plurality of sets of third image data in a third color space;
wherein, step (c) comprises multiplying the plurality of sets of image data by the saturation gain to adjust the image.

19. The image processing method according to claim 18, wherein the first color space is an RGB color space, the second color space is an HSV color space, and the third color space is a YCbCr color space; step (c) comprises multiplying values of Cb and Cr of the plurality of sets of third image data by the saturation gain to adjust the image.

20. The image processing method according to claim 11, wherein the image is included in a video stream, and the image processing method adjusts a plurality of images of the video stream.
